(19) United States
(12) Patent Application Publication
(10) Pub. No.: US 2013/0209840 A1
(43) Pub. Date: Aug. 15, 2013

(54) PARTICLES, PROCESS FOR PRODUCTION THEREOF AND USE THEREOF

(71) Applicants: Aleksei VOLKOV, Ludwigshafen (DE); Klaus Leitner, Ludwigshafen (DE); Martin Schulz-Dobrick, Mannheim (DE); Jordan Keith Lampert, Ludwigshafen (DE)

(72) Inventors: Aleksei VOLKOV, Ludwigshafen (DE); Klaus Leitner, Ludwigshafen (DE); Martin Schulz-Dobrick, Mannheim (DE); Jordan Keith Lampert, Ludwigshafen (DE)

(21) Appl. No.: 13/764,936

(22) Filed: Feb. 12, 2013

Related U.S. Application Data
(60) Provisional application No. 61/598,919, filed on Feb. 15, 2012.

(51) Int. Cl. H01M 4/485

(52) U.S. Cl. CPC H01M 4/485
USPC 429/50; 252/182.1; 252/506; 429/223

(57) ABSTRACT

Particles comprising a mixed oxide of the general formula (I)

Li₁₊ₐNi_{b}Co_{c}Mn_{d}O_{z} (I)

in which the variables are each defined as follows:
b is a number in the range from 0.25 to 0.45
c is a number in the range from 0.15 to 0.25

d=1−b−c,
(1+a) is in the range from 1.05 to 1.20,

1.8+a≦z≦2.2+a,

the particles having been fully or partially coated with one or more fluorides; and also a process for producing inventive particles and use of inventive particles.

The present invention relates to particles comprising a mixed oxide of the general formula (I)

Li₁₊ₐNi_{b}Co_{c}Mn_{d}O_{z} (I)

in which the variables are each defined as follows:
b is a number in the range from 0.25 to 0.45
c is a number in the range from 0.15 to 0.25

d=1−b−c

1.8+a≦z≦2.2+a
(1+a) is in the range from 1.05 to 1.20,
   the particles having been fully or partially coated with one or more fluorides.

The present invention further relates to a process for producing inventive particles. The present invention further relates to the use of inventive particles.

Electrochemical cells having a high storage capacity at maximum working voltage are of increasing importance. The desired capacities are generally unachievable with electrochemical cells which work on the basis of aqueous systems.

In lithium ion batteries, the charge transport is ensured not by protons in more or less hydrated form but by lithium ions in a nonaqueous solvent or in a nonaqueous solvent system. The electrode material takes on a particular role. Particularly high demands are made on the cathode material.

In many cases, those cathodes which are to work at high voltage, i.e., for example, at 4.3 V or more, are problematic. Under these circumstances, there is a threat of oxidation of the electrolyte, often combined with polymerization thereof. Polymer layers on the cathode can, however, act as insulators in the least favorable case and therefore lead to a distinct lowering of efficiency of the battery. Moreover, many cathode materials are found to lack cycling stability at such voltages, since too much lithium is taken out of the structure in the course of discharge (delithiation), and the structure of a corresponding cathode material can collapse.

It was thus an object of the present invention to provide materials which are suitable for production of cathodes which have a long lifetime even at high voltage, i.e., for example, at 4.3 V or more, and especially in the event of multiple significant delithiation. It was a further object of the present invention to provide a process by which materials which can be processed further to corresponding cathodes can be made. It was a further object of the present invention to provide electrodes and electrochemical cells which have a long lifetime even at high voltage and especially in the event of multiple significant delithiation.

Accordingly, the particles defined at the outset have been found, which are also called inventive particles in the context of the present invention.

In the context of the present inventions, “cycling” refers to the charging and discharging again of batteries or of electrochemical cells.

Inventive particles comprise at least one mixed oxide of the general formula (I)

Li₁₊ₐNi_{b}Co_{c}Mn_{d}O_{z} (I)

in which the variables are each defined as follows:
b is a number in the range from 0.25 to 0.45, preferably 0.37 to 0.42,
c is a number in the range from 0.15 to 0.25, preferably 0.17 to 0.22,

d=1−b−c,

(1+a) is in the range from 1.05 to 1.20, preferably 1.10 to 1.15,

1.8+a≦z≦2.2+a,

the particles having been fully or preferably partially coated with one or more fluorides.

In one embodiment of the present invention, inventive particles comprise at least two mixed oxides of the general formula (I). In another embodiment of the present invention, inventive particles comprise exactly one mixed oxide of the general formula (I).

In one embodiment of the present invention, inventive particles, aside from mixed oxide of the general formula (I), do not comprise any further Mn-, Co- or Ni-containing oxidic compounds. In another embodiment of the present invention, inventive particles may comprise Li₂MnO₃, for example in the range from 5 to 22 mol %, based on compound of the general formula (I).

In one embodiment of the present invention, inventive particles have a molar ratio of fluoride to sum of the transition metals in mixed oxide of the general formula (I) in the range from 0.02 to 0.15.

In one embodiment of the present invention, inventive materials have essentially layer structure, i.e. are layered oxides. The structure of the respective crystal lattice can be determined by methods known per se, for example X-ray diffraction or electron diffraction, especially by X-ray powder diffractometry.

In one embodiment of the present invention, inventive particles may have a BET surface area in the range from 0.1 to 5 m²/g, determined, for example, by nitrogen adsorption, for example to DIN ISO 9277:2003-05.

In one embodiment of the present invention, inventive materials may be doped with a total of up to 2% by weight of metal ions selected from cations of Na, K, Rb, Cs, alkaline earth metal, Ti, V, Cr, Fe, Cu, Ag, Zn, B, Al, Zr, Mo, W, Nb, Si, Ga and Ge, preferably with a total of up to one % by weight, based on overall compound (I). In a preferred embodiment of the present invention, inventive materials are not doped with other metal ions.

“Doping” shall be understood to mean that, in the course of production of inventive materials, in one or more steps, at least one compound having one or more cations selected from cations of Na, K, Rb, Cs, alkaline earth metal, Ti, V, Cr, Fe, Cu, Ag, Zn, B, Al, Zr, Mo, W, Nb, Si, Ga and Ge is added. Impurities introduced by slight contaminations of the starting materials, for example in the range from 0.1 to 100 ppm of sodium ions, based on the inventive material, shall not be referred to as doping in the context of the present invention.

In one embodiment of the present invention, inventive particles comprise up to a maximum of 1% by weight of sulfate or carbonate. In another embodiment of the present invention, inventive material does not have any detectable proportions of sulfate and/or carbonate.

In one embodiment of the present invention, compound of the general formula (I) is in the form of crystalline powder.

In one embodiment of the present invention, inventive particles are essentially spherical. In one embodiment of the present invention, inventive particles are essentially spherical, secondary agglomerates of primary particles. The particle diameter (D50) of the secondary agglomerates may be in the range from 1 to 30 μm, preferably in the range from 2 to 25 μm, more preferably in the range from 4 to 20 μm. Particle diameter (D50) in the context of the present invention refers to the mean particle diameter (weight average), as determinable, for example, by light scattering or by evaluation of electron micrographs.

“Essentially spherical” shall be understood to mean that inventive particles are either exactly spherical or else have round shapes, in which case the diameter at the largest point and the diameter at the smallest point do not differ from one another by more than 10%.

Inventive particles have been fully or partially coated with one or more fluorides, which means that the inventive particles have a coating with one or more fluorides. The coating shall be considered to be part of inventive particles.

In one embodiment of the present invention, at least 5% of the outer surface of inventive particles is covered with fluoride. This means the average value. In a preferred embodiment, 10 to 90% of the outer surface of inventive particles is covered with fluoride. The coverage can be determined, for example, by photoelectron spectroscopy (XPS) or electron microscopy (SEM, TEM).

Fluoride with which inventive particles have been coated may be in crystalline or in amorphous form.

In one embodiment of the present invention, fluorides are selected from LiF, NiF₂, CoF₂, MnF₂, and optionally mixed fluorides of at least two metals selected from Mn, Ni and Co, and from oxyfluorides of one or more metals selected from Ni, Mn and Co. Preference is given to fluorides selected from LiF, NiF₂, CoF₂ and MnF₂.

In one embodiment of the present invention, inventive particles are fully or partially coated with a mixture of fluorides, for example with two or more fluorides selected from LiF, NiF₂, CoF₂, MnF₂ and oxyfluorides of one or more metals selected from Ni, Mn and Co.

In one embodiment of the present invention, the fluoride(s) are arranged on the outer surface of inventive particles in the form of single crystals, or amorphous or crystalline layers.

In one embodiment of the present invention, fluoride is on the outer surface of inventive particles, but not in the pores. In another embodiment of the present invention, fluoride is not only on the outer surface but also in the pores of inventive particles, especially in the pores which result from the agglomeration of primary particles.

With the aid of inventive particles, it is possible to produce electrochemical cells with good properties. More particularly, it is observed that electrochemical cells produced with compound of the general formula (I) have a high discharge capacity when they are cycled against elemental lithium between 3.0 V and 4.6 V, and the electrochemical cells in question exhibit only a very small decline in potential, if any, in the course of cycling. The mean discharge potential should, in the course of cycling between 3.0 V and 4.6 V against elemental lithium and at current flow rates of 25 mA/g of inventive material, be greater than 3.5 V.

The present invention further provides electrodes comprising inventive particles.

Inventive particles can also be referred to in the context of the present invention as material (A).

In one embodiment of the present invention, inventive particles are used in inventive electrodes as a composite with electrically conductive, carbonaceous material. For example, inventive particles may be treated, for example coated, with electrically conductive, carbonaceous material. Such composites likewise form part of the subject matter of the present invention.

Electrically conductive, carbonaceous material can be selected, for example, from graphite, carbon black, carbon nanotubes, graphene or mixtures of at least two of the aforementioned substances. In the context of the present invention, electrically conductive, carbonaceous material can also be referred to as carbon (B) for short.

In one embodiment of the present invention, electrically conductive, carbonaceous material is carbon black. Carbon black may, for example, be selected from lamp black, furnace black, flame black, thermal black, acetylene black and industrial black. Carbon black may comprise impurities, for example hydrocarbons, especially aromatic hydrocarbons, or oxygen-containing compounds or oxygen-containing groups, for example OH groups. In addition, sulfur- or iron-containing impurities are possible in carbon black.

In one variant, electrically conductive, carbonaceous material is partially oxidized carbon black.

In one embodiment of the present invention, electrically conductive, carbonaceous material comprises carbon nanotubes. Carbon nanotubes (CNTs for short), for example single-wall carbon nanotubes (SW CNTs) and preferably multiwall carbon nanotubes (MW CNTs), are known per se. A process for production thereof and some properties are described, for example, by A. Jess et al. in Chemie Ingenieur Technik 2006, 78, 94-100.

In one embodiment of the present invention, carbon nanotubes have a diameter in the range from 0.4 to 50 nm, preferably 1 to 25 nm.

In one embodiment of the present invention, carbon nanotubes have a length in the range from 10 nm to 1 mm, preferably 100 nm to 500 nm.

Carbon nanotubes can be prepared by processes known per se. For example, a volatile carbon compound, for example methane or carbon monoxide, acetylene or ethylene, or a mixture of volatile carbon compounds, for example synthesis gas, can be decomposed in the presence of one or more reducing agents, for example hydrogen and/or a further gas, for example nitrogen. Another suitable gas mixture is a mixture of carbon monoxide with ethylene. Suitable temperatures for decomposition are, for example, in the range from 400 to 1000° C., preferably 500 to 800° C. Suitable pressure conditions for the decomposition are, for example, in the range from standard pressure to 100 bar, preferably to 10 bar.

Single- or multiwall carbon nanotubes can be obtained, for example, by decomposition of carbon compounds in a light arc, specifically in the presence or absence of a decomposition catalyst.

In one embodiment, the decomposition of volatile carbon-containing compound or carbon-containing compounds is performed in the presence of a decomposition catalyst, for example Fe, Co or preferably Ni.

In the context of the present invention, graphene is understood to mean almost ideally or ideally two-dimensional hexagonal carbon crystals with a structure analogous to single graphite layers.

In one embodiment of the present invention, in inventive electrodes, the weight ratio of inventive particles to electrically conductive, carbonaceous material is in the range from 200:1 to 5:1, preferably 100:1 to 10:1.

A further aspect of the present invention is an electrode, especially a cathode, comprising inventive particles, at least one electrically conductive, carbonaceous material and at least one binder. Inventive particles, at least one electrically conductive, carbonaceous material and at least one binder are combined to form electrode material which likewise forms part of the subject matter of the present invention.

Inventive particles and electrically conductive, carbonaceous material have been described above.

Suitable binders are preferably selected from organic (co)polymers. Suitable (co)polymers, i.e. homopolymers or copolymers, can be selected, for example, from (co)polymers obtainable by anionic, catalytic or free-radical (co)polymerization, especially from polyethylene, polyacrylonitrile, polybutadiene, polystyrene, and copolymers of at least two comonomers selected from ethylene, propylene, styrene, (meth)acrylonitrile and 1,3-butadiene. Polypropylene is also suitable. Polyisoprene and polyacrylates are additionally suitable. Particular preference is given to polyacrylonitrile.

In the context of the present invention, polyacrylonitrile is understood to mean not only polyacrylonitrile homopolymers but also copolymers of acrylonitrile with 1,3-butadiene or styrene. Preference is given to polyacrylonitrile homopolymers.

In the context of the present invention, polyethylene is not only understood to mean homopolyethylene, but also copolymers of ethylene which comprise at least 50 mol % of copolymerized ethylene and up to 50 mol % of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is not only understood to mean homopolypropylene, but also copolymers of propylene which comprise at least 50 mol % of copolymerized propylene and up to 50 mol % of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is not only understood to mean homopolymers of styrene, but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder is polybutadiene.

Other suitable binders are selected from polyethylene oxide (PEO), cellulose, carboxymethylcellulose, polyimides and polyvinyl alcohol.

In one embodiment of the present invention, binder is selected from those (co)polymers which have a mean molecular weight M_{w} in the range from 50 000 to 1 000 000 g/mol, preferably to 500 000 g/mol.

Binders may be crosslinked or uncrosslinked (co)polymers.

In a particularly preferred embodiment of the present invention, binder is selected from halogenated (co)polymers, especially from fluorinated (co)polymers. Halogenated or fluorinated (co)polymers are understood to mean those (co)polymers which comprise at least one (co)polymerized (co)monomer which has at least one halogen atom or at least one fluorine atom per molecule, preferably at least two halogen atoms or at least two fluorine atoms per molecule.

Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable binders are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

In one embodiment, in inventive electrodes, electrically conductive, carbonaceous material is selected from graphite, carbon black, carbon nanotubes, graphene or mixtures of at least two of the aforementioned substances.

In one embodiment of the present invention, inventive electrode material comprises:
(A) in the range from 60 to 98% by weight, preferably 70 to 96% by weight, of inventive particles,
(B) in the range from 1 to 25% by weight, preferably 2 to 20% by weight, of electrically conductive, carbonaceous material,
(C) in the range from 1 to 20% by weight, preferably 2 to 15% by weight, of binder.

The geometry of inventive electrodes can be selected within wide limits. It is preferred to configure inventive electrodes in thin layers, for example with a thickness in the range from 10 μm to 250 μm, preferably 20 to 130 μm.

In one embodiment of the present invention, inventive electrodes comprise a foil, for example a metal foil, especially an aluminum foil, or a polymer film, for example a polyester film, which may be untreated or siliconized.

The present invention further provides for the use of inventive electrode materials or inventive electrodes in electrochemical cells. The present invention further provides a process for producing electrochemical cells using inventive electrode material or inventive electrodes. The present invention further provides electrochemical cells comprising at least one inventive electrode material or at least one inventive electrode.

By definition, inventive electrodes in inventive electrochemical cells serve as cathodes. Inventive electrochemical cells comprise a counter-electrode, which is defined as the anode in the context of the present invention, and which may, for example, be a carbon anode, especially a graphite anode, a lithium anode, a silicon anode or a lithium titanate anode.

Inventive electrochemical cells may, for example, be batteries or accumulators.

Inventive electrochemical cells may comprise, in addition to the anode and inventive electrode, further constituents, for example conductive salt, nonaqueous solvent, separator, output conductor, for example made from a metal or an alloy, and also cable connections and housing.

In one embodiment of the present invention, inventive electrical cells comprise at least one nonaqueous solvent which may be liquid or solid at room temperature, preferably selected from polymers, cyclic or noncyclic ethers, cyclic and noncyclic acetals and cyclic or noncyclic organic carbonates.

Examples of suitable polymers are especially polyalkylene glycols, preferably poly-C₁-C₄-alkylene glycols and especially polyethylene glycols. These polyethylene glycols may comprise up to 20 mol % of one or more C₁-C₄-alkylene glycols in copolymerized form. The polyalkylene glycols are preferably polyalkylene glycols double-capped by methyl or ethyl.

The molecular weight M_{w} of suitable polyalkylene glycols and especially of suitable polyethylene glycols may be at least 400 g/mol.

The molecular weight M_{w} of suitable polyalkylene glycols and especially of suitable polyethylene glycols may be up to 5 000 000 g/mol, preferably up to 2 000 000 g/mol.

Examples of suitable noncyclic ethers are, for example, diisopropyl ether, di-n-butyl ether, 1,2-dimethoxyethane, 1,2-diethoxyethane, preference being given to 1,2-dimethoxyethane.

Examples of suitable cyclic ethers are tetrahydrofuran and 1,4-dioxane.

Examples of suitable noncyclic acetals are, for example, dimethoxymethane, diethoxymethane, 1,1-dimethoxyethane and 1,1-diethoxyethane.

Examples of suitable cyclic acetals are 1,3-dioxane and especially 1,3-dioxolane.

Examples of suitable noncyclic organic carbonates are dimethyl carbonate, ethyl methyl carbonate and diethyl carbonate.

Examples of suitable cyclic organic carbonates are compounds of the general formulae (II) and (III)

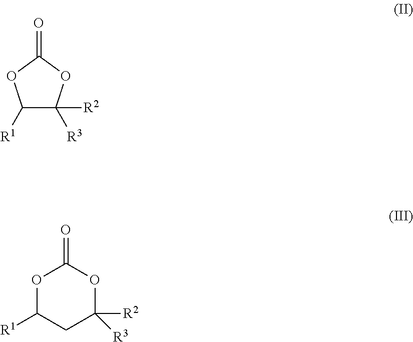

in which R¹, R² and R³ may be the same or different and are selected from hydrogen and C₁-C₄-alkyl, for example methyl, ethyl, n-propyl, isopropyl, n-butyl, isobutyl, sec-butyl and tert-butyl, where R² and R³ are preferably not both tert-butyl.

In particularly preferred embodiments, R¹ is methyl and R² and R³ are each hydrogen, or R¹, R² and R³ are each hydrogen.

Another preferred cyclic organic carbonate is vinylene carbonate, formula (IV).

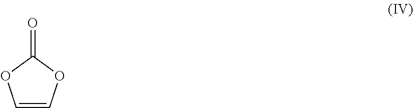

The solvent(s) is (are) preferably used in what is known as the anhydrous state, i.e. with a water content in the range from 1 ppm to 30 ppm, determinable, for example, by Karl Fischer titration. ppm refer to ppm by weight.

Inventive electrochemical cells further comprise one or more conductive salts. Suitable conductive salts are especially lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄, and salts of the general formula (CₙF₂ₙ₊₁SO₂)ₘXLi, where m is defined as follows:

m=1 when X is selected from oxygen and sulfur,
m=2 when X is selected from nitrogen and phosphorus, and
m=3 when X is selected from carbon and silicon.

Preferred conductive salts are selected from LiC(CF₃SO₂)₃, LiN(CF₃SO₂)₂, LiPF₆, LiBF₄, LiClO₄, particular preference being given to LiPF₆ and LiN(CF₃SO₂)₂.

In one embodiment of the present invention, inventive electrochemical cells comprise one or more separators by which the electrodes are mechanically separated. Suitable separators are polymer films, especially porous polymer films, which are unreactive toward metallic lithium. Particularly suitable materials for separators are polyolefins, especially porous polyethylene in film form and porous polypropylene in film form.

Separators made from polyolefin, especially made from polyethylene or polypropylene, may have a porosity in the range from 35 to 45%. Suitable pore diameters are, for example, in the range from 30 to 500 nm.

In another embodiment of the present invention, separators may be selected from PET nonwovens filled with inorganic particles. Such separators may have a porosity in the range from 40 to 55%. Suitable pore diameters are, for example, in the range from 80 to 750 nm.

In another embodiment of the present invention, separators made from fiberglass paper are selected.

Inventive electrochemical cells further comprise a housing which may have any desired shape, for example cuboidal or the shape of a cylindrical disk. In one variant, the housing used is a metal foil elaborated as a pouch.

Inventive electrochemical cells give a high potential and are notable for a high energy density and good stability. More particularly, it is observed that inventive electrochemical cells have a high discharge capacity if they are cycled against elemental lithium above 4.3 V, the inventive electrochemical cells exhibiting only a very small decline in potential, if any, in the course of cycling. The mean discharge potential in the course of cycling between 2.5 V and 4.55 V and at current flow rates of 95 mA/g of inventive material should be greater than 3.5 V.

Inventive electrochemical cells can be combined with one another, for example in series connection or in parallel connection. Series connection is preferred.

The present invention further provides for the use of inventive electrochemical cells in devices, especially in mobile devices. Examples of mobile devices are motor vehicles, for example automobiles, bicycles, aircraft, or water vehicles such as boats or ships. Other examples of mobile devices are those which are moved manually, for example computers, especially laptops, telephones, or power tools, for example from the building sector, especially drills, battery-powered drills or battery-powered tackers.

The use of inventive electrochemical cells in units gives the advantage of a particularly high volumetric energy density.

The present invention further provides a process for producing electrodes, which comprises mixing
(A) particles comprising a mixed oxide of the general formula (I)

Li₁₋ₐNi_{b}Co_{c}Mn_{d}O_{z} (I)

in which the variables are each defined as follows:
b is a number in the range from 0.25 to 0.45, preferably 0.37 to 0.42,
c is a number in the range from 0.15 to 0.25, preferably 0.17 to 0.22,

d=1−b−c
(1+a) is in the range from 1.05 to 1.20, preferably 1.10 to 1.15,

1.8+a≦z≦2.2+a

and where the particles have been fully or preferably partially coated with one or more fluorides, and
(B) at least one electrically conductive, carbonaceous material and
(C) at least one binder
   with one another in one or more steps, and optionally applying them to
(D) at least one metal foil or polymer film.

Inventive particles, electrically conductive, carbonaceous material or carbon (B) and binder (C) have been defined above.

The mixing can be effected in one or more steps.

In one variant of the process according to the invention, inventive particles, carbon (B) and binder (C) are mixed in one step, for example in a mill, especially in a ball mill. Subsequently, the mixture thus obtainable is applied in a thin layer to a carrier, for example a metal foil or polymer film (D). Before or on incorporation into an electrochemical cell, the carrier can be removed. In other variants, the carrier is retained.

In another variant of the process according to the invention, inventive particles, carbon (B) and binder (C) are mixed in a plurality of steps, for example in a mill, especially in a ball mill. For example, it is possible first to mix inventive particles and carbon (B) with one another. This is followed by mixing with binder (C). Subsequently, the mixture thus obtainable is applied in a thin layer to a carrier, for example a metal foil or polymer film (D). Before or on incorporation into an electrochemical cell, the carrier can be removed. In other variants, the carrier is not removed.

In one variant of the process according to the invention, inventive particles, carbon (B) and binder (C) are mixed in water or an organic solvent (e.g. N-methylpyrrolidone or acetone). The suspension thus obtainable is applied in a thin layer to a carrier, for example a metal foil or polymer film (D), and the solvent is then removed by a heat treatment. Before or on incorporation into an electrochemical cell, the carrier can be removed. In other variants, the carrier is not removed.

Thin layers in the context of the present invention may, for example, have a thickness in the range from 2 μm up to 250 μm.

To improve mechanical stability, the electrodes can be treated thermally or preferably mechanically, for example pressed or calendered.

The process according to the invention is very suitable for production of inventive electrode material and electrodes obtainable therefrom.

The present invention further provides composites comprising particles comprising at least one mixed oxide of the general formula (I)

Li₁₊ₐNi_{b}Co_{c}Mn_{d}O_{z} (I)

in which the variables are each defined as follows:
b is a number in the range from 0.25 to 0.45, preferably from 0.37 to 0.42,
c is a number in the range from 0.15 to 0.25, preferably from 0.17 to 0.22,

d=1−b−c,
(1+a) is in the range from 1.05 to 1.20, preferably from 1.10 to 1.15,

1.8+a≦z≦2.2+a,

the particles having been fully or partially coated with one or more fluorides, and
at least one electrically conductive, carbonaceous material, also called carbon (B).

In inventive composites, inventive particles have been treated, for example coated, with carbon (B).

In one embodiment of the present invention, in inventive composites, inventive particles and carbon (B) are present in a weight ratio in the range from 98:1 to 12:5, preferably 48:1 to 7:2.

Inventive composites are particularly suitable for production of inventive electrode material. A process for production thereof is described above and likewise forms part of the subject matter of the present invention.

The present invention further provides a process for producing inventive particles, also called synthesis process according to the invention. The synthesis process according to the invention can be performed by calcining hydroxides, carbonates, oxyhydroxides or basic carbonates of nickel, manganese and cobalt in the presence of a fluoride and of at least one lithium salt.

Specifically, the procedure may be to first produce a precursor which comprises the transition metals Ni, Co and Mn in the desired ratio and optionally the dopant(s), and then to calcine as described above. In a preferred variant, the procedure is to produce the precursor by precipitation of mixed carbonates, which may be basic, or of mixed oxyhydroxides. In a second step, mixing is effected first with a lithium compound, preferably with at least one lithium salt, for example with lithium hydroxide or more preferably with Li₂CO₃, and with at least one fluoride. This is followed by calcination, preferably at 875 to 950° C. for 3 to 12 hours, for example under an air flow.

In one embodiment of the present synthesis process, calcination is effected at a maximum temperature in the range from 875 to 950° C.

In one embodiment of the present invention, the fluoride selected is ammonium fluoride or ammonium hydrogendifluoride, or mixtures of ammonium fluoride and ammonium hydrogendifluoride.

The invention is illustrated by working examples.

General remark: Figures in percent are percent by weight, unless stated otherwise.

Stated amounts of dissolved salts are based on kg of solution.

### I. Preparation of Starting Materials

### I.1 Lithium Carbonate

Before use thereof, commercially available Li₂CO₃ was dried at 105° C. over a period of 16 hours and then particles having a diameter of more than 50 μm were removed by sieving.

### I.2 Preparation of Hydroxides (Precursors)

Ni_{0.4}Cu_{0.2}Mn_{0.4}(OH)₂ was added by combining a solution of NiSO₄, CoSO₄ and MnSO₄ with an aqueous solution of ammonia and NaOH while stirring vigorously, at a feed rate which corresponds to a residence time of 3 to 18 hours in the continuous reactor, at 55° C. Spherical particles of Ni_{0.4}Cu_{0.2}Mn_{0.4}(OH)₂ precipitated out. The mixed metal oxide/hydroxide formed was filtered off.

### II. Preparation of Inventive Materials and Comparative Materials

### II.1 Preparation of Comparative Material C-M.1

NCM-424, Li/metal=1.13

Ni_{0.4}Cu_{0.2}Mn_{0.4}(OH)₂ was dried under air at 105° C. over a period of 16 hours.

An agate mortar was initially charged with 6.34 g of Li₂CO₃ according to I.1, which were mixed intimately with 13.85 g of dried Ni_{0.4}Co_{0.2}Mn_{0.4}(OH)₂ over a period of 20 minutes. Thereafter, the mixture thus obtainable was calcined in a muffle furnace under air, running the following temperature profile:

First, the temperature was increased from room temperature to 350° C. by 3° C./min in each case. Heating was effected at 350° C. over a period of 4 hours. This was followed by an increase to 675° C., in the course of which the temperature was increased by 3° C./min in each case. Heating was effected at 675° C. over a period of 4 hours. This was followed by an increase to 900° C., in the course of which the temperature was increased by 3° C./min in each case. Calcination was effected at 900° C. over a period of 6 hours. Over the entire heating and calcination, air was passed through the muffle furnace (100 l/h).

The end of the calcination was followed by cooling, cooling rate: 0.5 K/min. This gave comparative material C-M.1, which was stored under nitrogen prior to further use.

### II.2 Preparation of Inventive Material M.2

NCM-424, Li/metal=1.13, 0.02 mol of F

An agate mortar was initially charged with 6.34 g of Li₂CO₃ according to 1.1, which were mixed intimately with 13.85 g of dried Ni_{0.4}Co_{0.2}Mn_{0.4}(OH)₂ over a period of 10 minutes. Thereafter, 0.13 g of NH₄F was added and the mixture was mixed again over a period of 10 minutes. Thereafter, the mixture thus obtainable was calcined in a muffle furnace under air, running the following temperature profile:

First, the temperature was increased from room temperature to 350° C. by 3° C./min in each case. Heating was effected at 350° C. over a period of 4 hours. This was followed by an increase to 675° C., in the course of which the temperature was increased by 3° C./min in each case. Heating was effected at 675° C. over a period of 4 hours. This was followed by an increase to 900° C., in the course of which the temperature was increased by 3° C./min in each case. Calcination was effected at 900° C. over a period of 6 hours. Over the entire heating and calcination, air was passed through the muffle furnace (100 l/h).

The end of the calcination was followed by cooling, cooling rate: 0.5 K/min. This gave inventive material M.2, which was stored under nitrogen prior to further use.

### II.3 Preparation of Inventive Material M.3

NCM-424, Li/metal=1.13, 0.1 mol of F

An agate mortar was initially charged with 6.34 g of Li₂CO₃ according to 1.1, which were mixed intimately with 13.85 g of dried Ni_{0.4}Cu_{0.2}Mn_{0.4}(OH)₂ over a period of 10 minutes. Thereafter, 0.57 g of NH₄F was added and the mixture was mixed again over a period of 10 minutes. Thereafter, the mixture thus obtainable was calcined in a muffle furnace under air, running the following temperature profile:

First, the temperature was increased from room temperature to 350° C. by 3° C./min in each case. Heating was effected at 350° C. over a period of 4 hours. This was followed by an increase to 675° C., in the course of which the temperature was increased by 3° C./min in each case. Heating was effected at 675° C. over a period of 4 hours. This was followed by an increase to 900° C., in the course of which the temperature was increased by 3° C./min in each case. Calcination was effected at 900° C. over a period of 6 hours. Over the entire heating and calcination, air was passed through the muffle furnace (100 l/h).

The end of the calcination was followed by cooling, cooling rate: 0.5 K/min. This gave inventive material M.3, which was stored under nitrogen prior to further use.

### II.4 Preparation of Inventive Material M.4

NCM-424, Li/metal=1.13, 0.2 mol of F

An agate mortar was initially charged with 6.34 g of Li₂CO₃ according to 1.1, which were mixed intimately with 13.85 g of dried Ni_{0.4}Cu_{0.2}Mn_{0.4}(OH)₂ over a period of 10 minutes. Thereafter, 1.14 g of NH₄F was added and the mixture was mixed again over a period of 10 minutes. Thereafter, the mixture thus obtainable was calcined in a muffle furnace under air, running the following temperature profile:

First, the temperature was increased from room temperature to 350° C. by 3° C./min in each case. Heating was effected at 350° C. over a period of 4 hours. This was followed by an increase to 675° C., in the course of which the temperature was increased by 3° C./min in each case. Heating was effected at 675° C. over a period of 4 hours. This was followed by an increase to 900° C., in the course of which the temperature was increased by 3° C./min in each case. Calcination was effected at 900° C. over a period of 6 hours. Over the entire heating and calcination, air was passed through the muffle furnace (100 l/h).

The end of the calcination was followed by cooling, cooling rate: 0.5 K/min. This gave inventive material M.4, which was stored under nitrogen prior to further use.

### II.5 Preparation of Inventive Material M.5

NCM-424, Li/metal=1.2, 0.1 mol of F

An agate mortar was initially charged with 6.74 g of Li₂CO₃ according to 1.1, which were mixed intimately with 13.85 g of dried Ni_{0.4}Cu_{0.2}Mn_{0.4}(OH)₂ over a period of 10 minutes. Thereafter, 0.57 g of NH₄F was added and the mixture was mixed again over a period of 10 minutes. Thereafter, the mixture thus obtainable was calcined in a muffle furnace under air, running the following temperature profile:

First, the temperature was increased from room temperature to 350° C. by 3° C./min in each case. Heating was effected at 350° C. over a period of 4 hours. This was followed by an increase to 675° C., in the course of which the temperature was increased by 3° C./min in each case. Heating was effected at 675° C. over a period of 4 hours. This was followed by an increase to 900° C., in the course of which the temperature was increased by 3° C./min in each case. Calcination was effected at 900° C. over a period of 6 hours. Over the entire heating and calcination, air was passed through the muffle furnace (100 l/h).

The end of the calcination was followed by cooling, cooling rate: 0.5 K/min. This gave inventive material M.5, which was stored under nitrogen prior to further use.

### III. Electrochemical Analysis:

III.1 Analyses with Inventive Half Cells

To produce a cathode (Kat-hz-2), the following were mixed with one another in a screwtop vessel:

### 88% M.2

6% polyvinylidene difluoride (“PVdF”), commercially available as Kynar Flex® 2801 from Arkema Group,
3% carbon black, BET surface area of 62 m²/g, commercially available as “Super P Li” from Timcal,
3% graphite, commercially available as KS6 from Timcal.
While stirring, a sufficient amount of N-methylpyrrolidone (NMP) was added and the mixture was stirred with an Ultraturrax until a stiff, lump-free paste had been obtained.

Then the paste thus obtained was knife-coated onto aluminum foil of thickness 20 μm and dried in a vacuum drying cabinet at 120° C. for 16 hours. The loading after drying was 1.1 mg/cm². Subsequently, circular disk-shaped segments were punched out, area: 3 cm². This gave inventive cathode (Kat-hz-2).

Anode (An-hz-1): a lithium disk, area 3 cm², was punched out. This gave anode (An-hz-1).

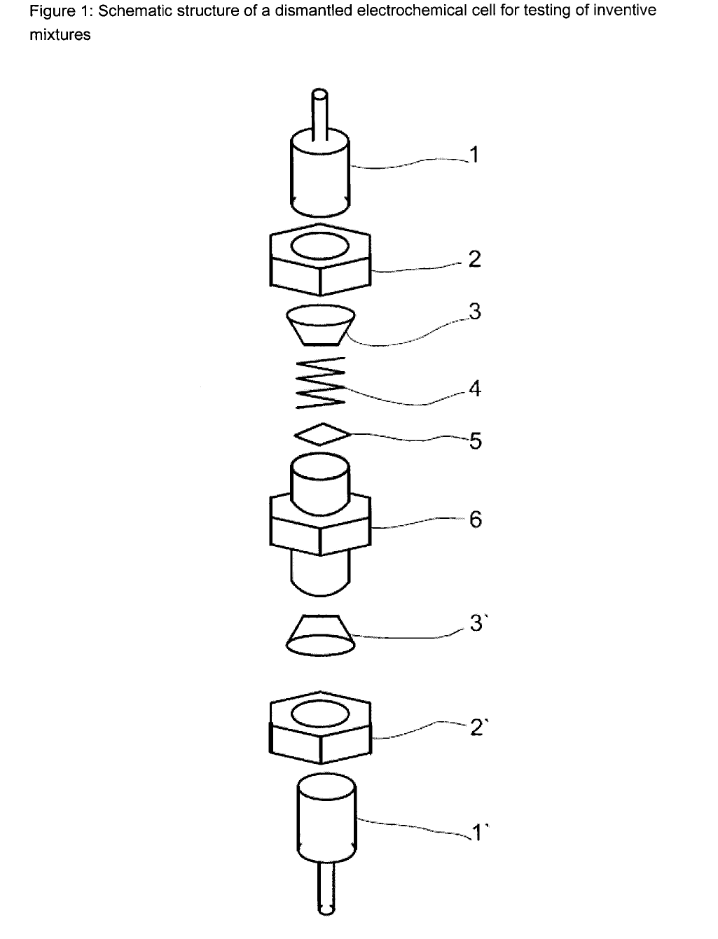

The test cell used was a setup according to FIG. 1. In the assembly of the cell, it was put together from the bottom upward according to the schematic diagram, FIG. 1. In FIG. 1, the anode side is at the top, the cathode side at the bottom.

The labels in FIG. 1 mean:
1, 1′ Bolt
2, 2′ Nut
3, 3′ Sealing ring—two in each case, the second, somewhat smaller sealing ring in each case is not shown here
4 Spiral spring
5 Output conductor made of stainless steel
6 Housing

Cathode (Kat-hz-2) was applied to the bolt on the cathode side 1′. Subsequently, a separator composed of glass fibers, thickness of the separator: 0.5 mm, was placed onto cathode (Kat-hz-2). Electrolyte was trickled onto the separator. Anode (An-hz-1) was placed onto the soaked separators. The output conductor 5 used was a stainless steel plate which was applied directly to the anode. Subsequently, the seals 3 and 3′ were added and the parts of the test cell were screwed together. By means of the steel spring configured as spiral spring 4, and by virtue of the pressure which was generated by the screw connection with anode bolt 1, electrical contact was ensured.

Inventive cells based on inventive materials M.3 to M.5 or comparative material C-M.1 were produced analogously.

The electrolyte used was a 1 M solution of LiPF₆ in ethyl methyl carbonate/diethyl carbonate (volume ratio 1:1).

This gave an inventive electrochemical cell which was tested at 25° C., specifically at a potential range of the cell: 3.0 V-4.3 V or 3.0 V-4.6 V.

The following cycling program was run:

charge 0.1 C, discharge 0.1 C 2×
charge 0.2 C, discharge 0.2 C 5×
charge 0.2 C, discharge 0.4 C 1×
charge 0.2 C, discharge 0.8 C 1×
charge 0.2 C, discharge 1.6 C 1×
charge 0.2 C, discharge 3.2 C 1×
charge 0.2 C, discharge 6.4 C 1×
charge 0.1 C, discharge 0.1 C 2× (or 1×)
charge 0.2 C, discharge 0.2 C 5×
charge 0.2 C, discharge 1 C 1×
charge 0.4 C, discharge 1 C 1×
charge 1 C, discharge 1 C 53×
charge 0.2 C, discharge 0.2 C 3×
charge 1 C, discharge 1 C 53×
charge 0.2 C, discharge 0.2 C 3×.

The loss of capacity in half cells on rapid discharge was extremely small.

III.2 Analysis with Inventive Full Cells

### Production of Full Cells:

To produce a cathode (Kat-vz-2), the following were mixed with one another in a screwtop vessel:

### 85.2% M.2

8.3% polyvinylidene difluoride (“PVdF”), commercially available as Kynar Flex® 2801 from Arkema Group,
3.2% carbon black, BET surface area of 62 m²/g, commercially available as “Super P Li” from Timcal,
3.3% graphite, commercially available as KS6 from Timcal.
While stirring, a sufficient amount of N-methylpyrrolidone (NMP) was added and the mixture was stirred with an Ultraturrax until a stiff, lump-free paste had been obtained.

Then the paste thus obtained was knife-coated onto aluminum foil of thickness 20 μm and dried in a vacuum drying cabinet at 120° C. for 16 hours. The loading after drying was 1.1 mg/cm². Subsequently, circular disk-shaped segments were punched out, area: 1.13 cm². This gave inventive cathode (Kat-vz-2).

Electrochemical testing was conducted in “Swagelok” cells. The electrolyte used was a 1 M solution of LiPF₆ in ethyl methyl carbonate/ethylene carbonate (volume ratio 1:1).

Separator: glass fiber. Anode: graphite. Temperature: 25° C. Potential range of the cell: 2.50 V-4.525 V. Cycling program: 0.1 C (first and second cycles), 0.5 C (from the third cycle). 1 C=190 mA/g.

### Results:

The loss of capacity in full cells according to Table 1 was calculated as follows: the difference in the mean capacity after 70 cycles and after 2 cycles, divided by the mean capacity after 70 cycles and multiplied by 100 gives the loss of capacity (“fading”).

TABLE 1
Results of the loss of capacity in analyses in full cells:

| Cathode used | Loss of capacity [%] |
|---|---|
| (kat-vz-2) | 10 |
| (kat-vz-3) | 8 |

1. Particles comprising a mixed oxide of the general formula (I)
Li₁₊ₐNi_{b}Co_{c}Mn_{d}O_{z} (I)
in which the variables are each defined as follows:
b is a number in the range from 0.25 to 0.45
c is a number in the range from 0.15 to 0.25
1.8+a≦z≦2.2+a
d=1−b−c
(1+a) is in the range from 1.05 to 1.20,
the particles having been fully or partially coated with one or more fluorides.

2. Particles according to claim 1, wherein the molar ratio of fluoride to sum of the transition metals in mixed oxide of the general formula (I) is in the range from 0.02 to 0.15.

3. Particles according to claim 1 or 2, wherein at least 5% of the outer surface of the particles is covered with fluoride.

4. Particles according to any of claims 1 to 3, wherein fluorides are selected from LiF, NiF₂, CoF₂, MnF₂ and oxyfluorides of one or more metals selected from Ni, Mn and Co.

5. Particles according to any of claims 1 to 4, which have a mean diameter (D50) in the range from 1 to 30 μm.

6. Particles according to any of claims 1 to 5, which are essentially spherical.

7. Particles according to any of claims 1 to 6, which comprise Li₂MnO₃.

8. The use of particles according to any of claims 1 to 7 for production of electrodes.

9. An electrode comprising particles according to any of claims 1 to 8, at least one electrically conductive, carbonaceous material and at least one binder.

10. The electrode according to claim 9, wherein electrically conductive, carbonaceous material is selected from graphite, carbon black, carbon nanotubes, graphene or mixtures of at least two of the aforementioned substances.

11. The use of particles according to any of claims 1 to 7 or of electrodes according to claim 9 or 10 in electrochemical cells.

12. A process for producing electrochemical cells using particles according to any of claims 1 to 7 or electrodes according to claim 9 or 10.

13. A process for producing electrodes using particles according to any of claims 1 to 7 or electrodes according to claim 9 or 10.

14. An electrochemical cell comprising electrode material according to any of claims 1 to 7 or at least one electrode according to claim 9 or 10.

15. The use of electrochemical cells according to claim 14 as a power source in mobile devices.

16. The use of electrochemical cells according to claim 14 or 15, wherein the mobile device is an automobile, a bicycle, an aircraft, a computer, a telephone or a power tool.

17. A process for producing particles according to any of claims 1 to 7, which comprises calcining hydroxides, carbonates, oxyhydroxides or basic carbonates of nickel, manganese and cobalt in the presence of a fluoride and of at least one lithium salt.

18. The process according to claim 17, wherein the fluoride selected is ammonium fluoride or ammonium hydrogendifluoride.
